(19) United States
(12) Patent Application Publication
(10) Pub. No.: US 2024/0144154 A1
(43) Pub. Date: May 2, 2024

(54) ONE-WAY DATA PROCESSING SYSTEM

(71) Applicant: INSTITUTE FOR INFORMATION INDUSTRY, Taipei City (TW)

(72) Inventor: Mao-Chi HUANG, Taipei City (TW)

(73) Assignee: INSTITUTE FOR INFORMATION INDUSTRY, Taipei City (TW)

(21) Appl. No.: 18/071,482

(22) Filed: Nov. 29, 2022

(30) Foreign Application Priority Data
Nov. 2, 2022 (TW) 111141796

(51) Int. Cl. G06Q 10/08; G01G 11/04

(52) U.S. Cl. CPC G06Q 10/08; G01G 11/04

(57) ABSTRACT

A one-way data processing system includes a conveyor device, an image capturing device, a trigger device, a first processing device and a second processing device. The first processing device identifies a type of the target object according to image data captured by the image capturing device. The first or the second processing device obtains a weight of the target object, and obtains exit information according to a level-exit correspondence table and the type and the weight of the object. The second processing device drives a swing arm of the conveyor device at least according to a trigger signal generated by the trigger device triggered by the target object and the exit information, to unload the target object through a target exit location. A data transmission direction between the first processing device and the second processing device only includes a direction from the first processing device to the second processing device.

### CROSS-REFERENCE TO RELATED APPLICATIONS

This non-provisional application claims priority under 35 U.S.C. § 119(a) on Patent Application No(s). 111141796 filed in Republic of China (ROC) on Nov. 2, 2022, the entire contents of which are hereby incorporated by reference.

### BACKGROUND

### 1. Technical Field

This disclosure relates to a data processing system, especially to a one-way data processing system.

### 2. Related Art

Conveyor apparatus can transport objects continuously and efficiently, and is easy to use, which can effectively reduce manpower and transportation costs. Therefore, the conveyor apparatus is widely used in the fields of fishery, agriculture, industry and mining to transport various solid materials or finished items.

Generally, the conveying system includes at least two processing devices, such as a computer and a programmable logic controller, and the two processing devices communicate with each other to control the operation of the conveying apparatus. However, since the two processing devices do not adopt a real-time operating system (RTOS), a delay is easily generated in response, which leads to the inability of the two processing devices to uniformly control the operation of the conveyor apparatus, leading to erroneous control condition of the conveyor apparatus.

### SUMMARY

Accordingly, this disclosure provides a one-way data processing system.

According to one or more embodiment of this disclosure, a one-way data processing system includes: a conveyor device, an image capturing device, a trigger device, a first processing device and a second processing device. The conveyor device includes a conveyor belt and a number of swing arms, the swing arms are configured to unload a target object at one of a number of candidate exit locations. The image capturing device is disposed at the conveyor device, and configured to capture image data of the target object. The trigger device is disposed at the conveyor belt, and is configured to be triggered by the target object to generate a trigger signal. The first processing device is connected to the image capturing device, and is configured to identify a type of the target object according to the image data. The second processing device is connected to the trigger device and the first processing device, and is configured to drive the swing arms to unload the target object at a target exit location corresponding to the exit information among the candidate exit locations at least according to the trigger signal and exit information. The first processing device or the second processing device is further configured to obtain a weight of the target object and obtain the exit information according to a level-exit correspondence table, the type of the target object and the weight of the target object, wherein the level-exit correspondence table includes a number of type-weight levels corresponding to the candidate exit locations respectively, and a data transmission direction between the first processing device and the second processing device only includes a direction from the first processing device to the second processing device.

Through the above structure, the one-way data processing system of the present disclosure may allow signal transmission from the first processing device to the second processing device to be more stable, without delay and error caused by back-and-forth communication. The one-way data processing system of the present disclosure may further automatically select target object, replacing the traditional way of relying on human eyes and worker's experience to perform recognition, thereby improving the accuracy of production line operations and reduce labor costs.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram illustrating a one-way data processing system according to an embodiment of the present disclosure;

FIG. 2 is a schematic diagram illustrating a memory of a second processing device of the one-way data processing system according to an embodiment of the present disclosure;

FIG. 3 is a schematic diagram illustrating a circular queue of the second processing device of the one-way data processing system according to an embodiment of the present disclosure;

FIG. 4 is a functional block diagram illustrating a one-way data processing system according to another embodiment of the present disclosure;

FIG. 5 is a flowchart illustrating an operation of the one-way data processing system according to an embodiment of the present disclosure; and

FIG. 6 is a flowchart illustrating an operation of the one-way data processing system according to another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

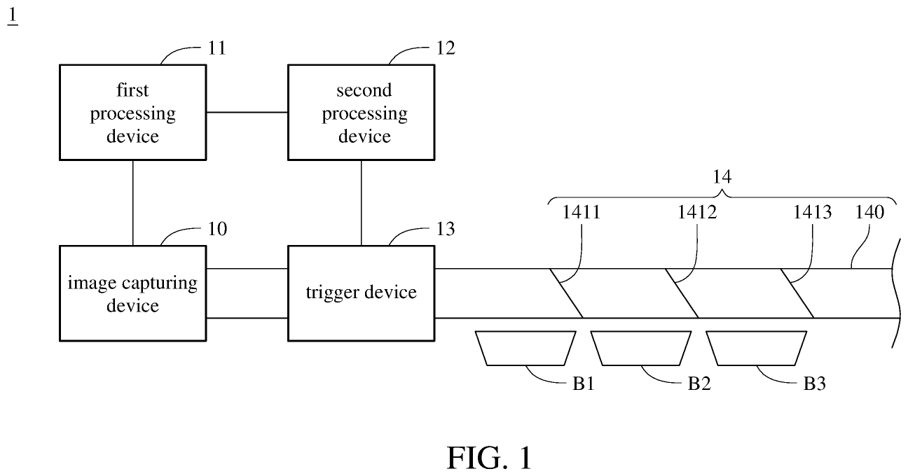

Please refer to FIG. 1, FIG. 1 is a functional block diagram illustrating a one-way data processing system according to an embodiment of the present disclosure. The one-way data processing system 1 is a system configured to perform classification on a target object transported by a conveyor device 14, wherein the target object may be fishery, meat, vegetables, parcels or any other objects that are transported and classified by the conveyor belt. As shown in FIG. 1, the one-way data processing system 1 includes an image capturing device 10, a first processing device 11, a second processing device 12, a trigger device 13 and a conveyor device 14. The conveyor device 14 includes a conveyor belt 140 and a number of swing arms 1411, 1412 and 1413. Specifically, a transportation direction of the conveyor belt 140 is from the image capturing device 10 to the trigger device 13. The conveyor belt 140 has a number of candidate exit locations correspond to baskets B1, B2 and B3 shown in FIG. 1 respectively, wherein the baskets B1, B2 and B3 are selectively disposed. FIG. 1 exemplarily shows the conveyor belt 140 has three candidate exit locations corresponding to the baskets B1, B2 and B3 respectively, and the conveyor device 14 includes a first swing arm 1411, a second swing arm 1412 and a third swing arm 1413, but the present disclosure does not limit the number of exit locations and swing arms of the conveyor belt.

The image capturing device 10 may be a camera, a digital video camera etc. The image capturing device 10 is disposed at the conveyor belt 140, and configured to capture image(s) of the target object that is about to be transported by the conveyor belt 140 to obtain image data. In other words, the image data may include one frame of image or consecutive frames of images.

The first processing device 11 is electrically connected to the image capturing device 10 or in communication connection with the image capturing device 10. The first processing device 11 is, for example, a computer, and configured to receive the image data from the image capturing device 10, and identify the type of the target object according to the image data. Take fishery for example, said type may be fish type (or referred to as fish species). Specifically, the first processing device 11 may store a type recognition model (for example, model trained with convolutional neural network algorithms) trained by a number of pieces of image data tagged with fish types, and determine the type of the target object by using the type recognition model to perform recognition on the image data. In addition, the first processing device 11 may further store other type recognition models of other species of target objects that are trained in the similar fashion, for the user to select the species of the target object to be identified and classified through the first processing device 11 when using the system.

The second processing device 12 is electrically connected to or in communication connection with the first processing device 11, and especially connected to the first processing device 11 through network cable. The second processing device 12 is also electrically connected to or in communication connection with the trigger device 13, and is electrically connected to or in communication connection with the swing arms 1411 to 1413. The second processing device 12 is, for example, a programmable logic controller (PLC), and configured to drive the swing arms 1411 to 1413 at least according to signals from the first processing device 11 and the trigger device 13, for the target object on the conveyor belt 140 to be unloaded from a target exit location among a number of candidate exit locations.

It should be noted that, the above description uses the first processing device 11 being a computer and the second processing device 12 being a PLC for example, but the first processing device 11 and the second processing device 12 may also be other combinations of processing devices with different data processing speeds, wherein the data processing speed of the first processing device 11 is especially higher than the data processing speed of the second processing device 12. Further, a data transmission direction between the first processing device 11 and the second processing device 12 only includes from the first processing device 11 to the second processing device 12. Through the one-way transmission, signal transmission from the first processing device 11 to the second processing device 12 may be more stable, and there would be no delay and error caused by back-and-forth communication.

The trigger device 13 is disposed at the conveyor belt 140 of the conveyor device 14, and is preferably disposed at an entrance of the conveyor belt 140. The trigger device 13 is configured to be triggered by the target object to generate a trigger signal. The trigger device 13 may include but not limited to a combination of a pressure sensor, an infrared transmitter and an infrared sensor etc. In an embodiment of the trigger device 13 including the pressure sensor, the trigger signal may be a signal generated by the pressure sensor when sensing a pressure. In an embodiment of the trigger device 13 including the infrared transmitter and the infrared sensor, the infrared transmitter may emit infrared rays continuously or at regular intervals, the infrared rays are received by the infrared sensor, and the trigger device 13 generates the trigger signal when the infrared ray is cut off (interrupted).

The conveyor device 14 is configured to unload the target object to one of the baskets B1 to B3 through the corresponding one of the candidate exit locations. Moreover, the swing arms 1411 to 1413 are driven by the second processing device 12 to unload the target object through the target exit location among the candidate exit locations. FIG. 1 exemplarily shows three swing arms, but the present disclosure does not limit the number of swing arms of the conveyor device 14.

In the operation of the one-way data processing system 1, the first processing device 11 may pre-store an area-weight correspondence table and a level-exit correspondence table associated with the target object. The first processing device 11 may further calculate an area of the target object according to the image data, obtain a weight of the target object according to the area of the target object and the area-weight correspondence table, obtain exit information according to the level-exit correspondence table, the type of the target object and the weight of the target object, and transmit the exit information to the second processing device 12, for the second processing device 12 to drive the swing arms 1411 to 1413 according to the exit information to unload the target object. In other words, the exit information may include information of the target exit location.

Specifically, the area-weight correspondence table records weight ranges corresponding to different area ranges. For example, since different fish types have different average thickness ranges, the area-weight correspondence table may be generated by generalizing the weight range of each fish types corresponding to different area ranges. Therefore, when a result generated based on the image data obtained by the image capturing device 10 shows an area of the target object is 53 cm² and the type of the target object is mackerel, the first processing device 11 converts the area 53 cm² of mackerel into a corresponding weight 230 g according to the area-weight correspondence table to obtain the weight of the target object; when a result generated based on the image data obtained by the image capturing device 10 shows an area of the target object is 53 cm² and the type of the target object to be horse mackerel, the first processing device 11 converts the area 53 cm² of horse mackerel into a corresponding weight 255 g according to the area-weight correspondence table. Preferably, the area-weight correspondence table may be obtained by machine learning. The first processing device 11 may calculate the area of the target object according to the image data, look up the area-weight correspondence table according to the area-weight correspondence table corresponding to the target object and the calculated area to obtain the weight of the target object. Moreover, the first processing device 11 may obtain a contour of the target object in the image by performing edge detection, and then calculate an area circled by the contour as the area of the target object.

The level-exit correspondence table includes a number of type-weight levels corresponding to a number of candidate exit locations respectively. Specifically, the level-exit correspondence table may be table 1 as shown below, wherein the level-exit correspondence table of table 1 uses fishery as an example, and table 1 exemplarily shows nine candidate exit locations, but the present disclosure is not limited thereto. As shown in table 1, the level-exit correspondence table includes a number of type-weight levels and the corresponding candidate exit locations.

TABLE 1

| type-weight | candidate |
|---|---|
| level | exit location |
| mackerel | the first candidate |
| (150 g~200 g) | exit location |
| mackerel | the second candidate |
| (201 g~250 g) | exit location |
| mackerel | the third candidate |
| (251 g~300 g) | exit location |
| horse mackerel | the fourth candidate |
| (201 g~250 g) | exit location |
| horse mackerel | the fifth candidate |
| (251 g~300 g) | exit location |
| round scad | the sixth candidate |
| (100 g~150 g) | exit location |
| round scad | the seventh candidate |
| (151 g~200 g) | exit location |
| round scad | the eighth candidate |
| (201 g~250 g) | exit location |
| round scad | the ninth candidate |
| (251 g~300 g) | exit location |

In an embodiment, a time interval of transporting target object on the conveyor belt 140 may be preset to a fixed time interval. The second processing device 12 may determine a time point (referred to as “starting time point” hereinafter) of the target object at the trigger device 13 according to the trigger signal, determine an arriving time point of the target object arriving at the target exit location according to the starting time point, the exit information and the fixed time interval, and drive a corresponding one of the swing arms 1411 to 1413 at the arriving time point to unload the target object through the target exit location. The fixed time interval may indicate that one target object is sent to the location of the trigger device 13 every fixed time interval, the fixed time interval may also indicate a time interval required for transporting the target object from one candidate exit location to the next candidate exit location. The fixed time interval is, for example, 1 second, 2 seconds etc., the present disclosure is not limited thereto.

In another embodiment, the second processing device 12 may pre-store distances between a location of the conveyor belt 140 where the trigger device 13 is disposed and each of the candidate exit locations and/or a coordinate of the conveyor belt 140 where the trigger device 13 is disposed and coordinates of the candidate exit locations, and pre-store a transportation speed of the conveyor belt 140. The second processing device 12 may determine a time point of driving one of the swing arms 1411 to 1413 according to a time point of generating the trigger signal, the exit information and the pre-stored data described above.

In the example where the second processing device 12 pre-stores a distance between an entrance location of the conveyor belt 140 and each of the candidate exit locations, the second processing device 12 may determine a distance between the trigger device 13 and the target exit location according to the exit information, and determine a duration of transporting the target object from the trigger device 13 to the target exit location according to the distance and a predetermined transportation speed of the conveyor belt 140. Accordingly, the second processing device 12 may determine the arriving time point of the target object arriving at the target exit location according to the starting time point and said duration, and drive one of the swing arms 1411 to 1413 at the arriving time point to unload the target object through the target exit location.

In the example where the second processing device 12 pre-stores a coordinate of the trigger device 13 disposed on the conveyor belt 140 and a coordinate of each candidate exit location, the second processing device 12 may determine a distance according to the coordinate of the trigger device 13 and the coordinate of the target exit location, determine the starting time point of the target object at the trigger device 13 according to the trigger signal, and further determine the arriving time point of the target object arriving at the target exit location according to the predetermined transportation speed of the conveyor belt 140. For example, if a recognition result of the first processing device 11 indicates that the type of the target object is mackerel, and the weight of the target object is 230 g, then the second processing device 12 may determine the exit information according to table 1, wherein the exit information includes that the candidate exit location corresponding to the second swing arm 1412 is the target exit location of the target object. Then, the second processing device 12 determines the starting time point of the target object at the trigger device 13 according to the trigger signal, determines the distance between the trigger device 13 and the target exit location according to the exit information, and further determines the arriving time point of the target object arriving at the target exit location according to the predetermined transportation speed of the conveyor belt 140. Then, the second processing device 12 drives the second swing arm 1412 according to the arriving time point, to unload the target object through the target exit location and into the basket B2.

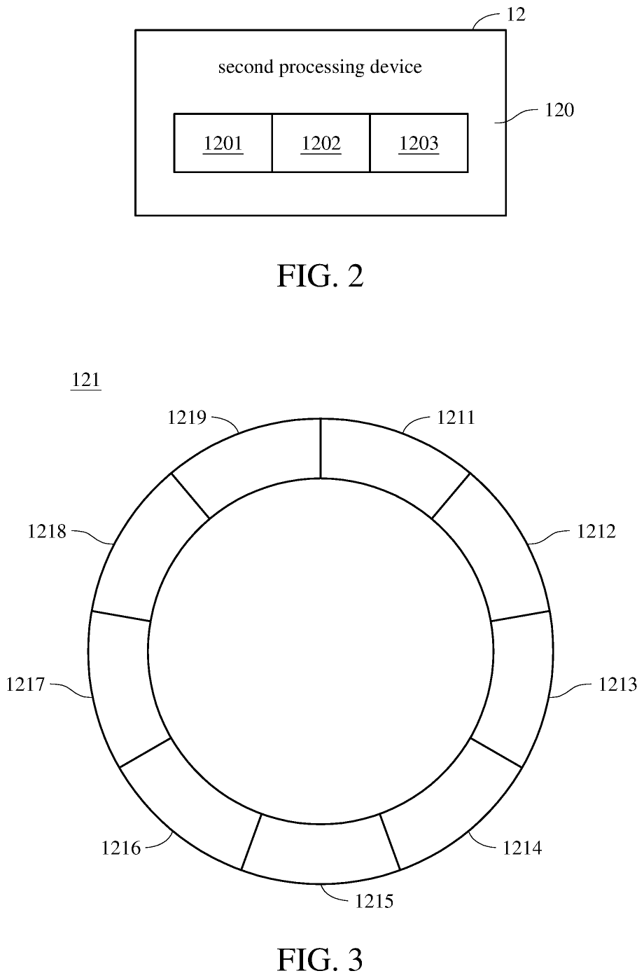

Please refer to FIG. 1 and FIG. 2, wherein FIG. 2 is a schematic diagram illustrating a memory of a second processing device of the one-way data processing system according to an embodiment of the present disclosure. As shown in FIG. 2, the second processing device 12 of the above embodiment may include a memory 120, and the memory 120 includes a number of memory blocks 1201 to 1203. The memory 120 is especially non-volatile memory, such as read-only memory (ROM), flash memory or non-volatile random access memory etc. FIG. 2 exemplarily shows three memory blocks, but the present disclosure does not limit the number of memory blocks of the memory 120.

Each of the memory blocks 1201 to 1203 of the memory 120 records the accumulated weight of a respective one of the candidate exit locations. Take table 1 as an example, the memory block 1201 records the accumulated weight of mackerel unloaded from the corresponding candidate exit location to the basket B1 through the first swing arm 1411; the memory block 1202 records the accumulated weight of mackerel unloaded from the corresponding candidate exit location to the basket B2 through the second swing arm 1412; and the memory block 1203 records the accumulated weight of mackerel unloaded from the corresponding candidate exit location to the basket B3 through the third swing arm 1413. In other words, each of the weights of mackerel recorded by the memory block 1201 falls within a range of 150 g-200 g, each of the weights of mackerel recorded by the memory block 1202 falls within a range of 201 g-250 g, and each of the weights of mackerel recorded by the memory block 1203 falls within a range of 251 g-300 g.

In addition, as shown in table 2 below, in addition to the type-weight levels and the candidate exit locations, the level-exit correspondence table may further include a number of candidate memory locations corresponding to the candidate exit locations respectively, wherein the candidate memory locations correspond to the memory blocks of the memory 120 respectively. The accumulated weight shown in table 2 indicates the accumulated weight recorded by the memory block with corresponding candidate memory location, and may be included in the level-exit correspondence table selectively. The first processing device 11 may further transmits the weight of the target object and a target memory location, among the candidate memory locations, corresponding to the target exit location to the second processing device 12 when obtaining the exit information, for the second processing device 12 to add the weight of the target object to the accumulated weight of the target exit location.

TABLE 2

| type-weight | candidate | accumulated | | candidate |
|---|---|---|---|---|
| level | memory location | weight | | exit location |
| mackerel | first candidate | 15,600 | g | first candidate |
| (150 g~200 g) | memory location | | | exit location |
| mackerel | second candidate | 1,250 | g | second candidate |
| (201 g~250 g) | memory location | | | exit location |
| mackerel | third candidate | 780 | g | third candidate |
| (251 g~300 g) | memory location | | | exit location |
| horse mackerel | fourth candidate | 603 | g | fourth candidate |
| (201 g~250 g) | memory location | | | exit location |
| horse mackerel | fifth candidate | 1,604 | g | fifth candidate |
| (251 g~300 g) | memory location | | | exit location |
| round scad | sixth candidate | 450 | g | sixth candidate |
| (100 g~150 g) | memory location | | | exit location |
| round scad | seventh candidate | 770 | g | seventh candidate |
| (151 g~200 g) | memory location | | | exit location |
| round scad | eighth candidate | 460 | g | eighth candidate |
| (201 g~250 g) | memory location | | | exit location |
| round scad | ninth candidate | 13,608, | | ninth candidate |
| (251 g~300 g) | memory location | | | exit location |

For example, when the first processing device 11 obtains the exit information and the exit information indicates the second candidate exit location corresponding to the second swing arm 1412 is the target exit location, the first processing device 11 transmits the weight of the target object to the second processing device 12 to use the second candidate memory location corresponding to the target exit location as the target memory location, and transmits the target memory location to the second processing device 12. Accordingly, the second processing device 12 may add the weight of the target object to the accumulated weight of the target exit location according to the target memory location.

Please refer to FIG. 1 and FIG. 3, wherein FIG. 3 is a schematic diagram illustrating a circular queue of the second processing device of the one-way data processing system according to an embodiment of the present disclosure. The buffer memory of the second processing device 12 may include a circular queue 121, the first processing device 11 may transmit the exit information to the second processing device 12 by writing the exit information into the circular queue 121. Moreover, in buffer areas 1211 to 1219 of the circular queue 121, the first processing device 11 may write the exit information into a buffer area which currently does not record exit information, and this buffer area may be next to a buffer area which already records another piece of exit information.

For example, assuming that among sequentially connected buffer areas 1211 to 1219 of the circular queue 121, a first buffer area 1211 and a second buffer area 1212 already records exit information, but a third buffer area 1213 to a ninth buffer area 1219 do not record exit information, then the first processing device 11 may write the current exit information into the third buffer area 1213.

After the second processing device 12 triggers the corresponding swing arm to unload the target object, the second processing device 12 may delete the exit information from one of the buffer areas 1211 to 1219 corresponding to the target object. For example, assuming that the first buffer area 1211 stores first exit information, the second buffer area 1212 stores second exit information, and the third buffer area 1213 stores third exit information, then after the second processing device 12 drives the swing arm to unload the target object corresponding to the first exit information, the second processing device 12 may delete the first exit information from the first buffer area 1211, and process the unloading of the target object corresponding to the second exit information of the second buffer area 1212.

It should be noted that, the present disclosure does not limit the number of buffer areas of the circular queue 121. After the current target object is unloaded, the second processing device 12 may delete the corresponding exit information from the buffer area. Through the structure of the circular queue 121, the information of the target exit location of the target object generated by the first processing device 11 may be avoided from being overwritten by another piece of exit information of another target object generated by the first processing device 11 before read by the second processing device 12. Therefore, the target object may be unloaded from the correct exit location, thereby solving the problem of error caused by different processing speeds of two processing devices.

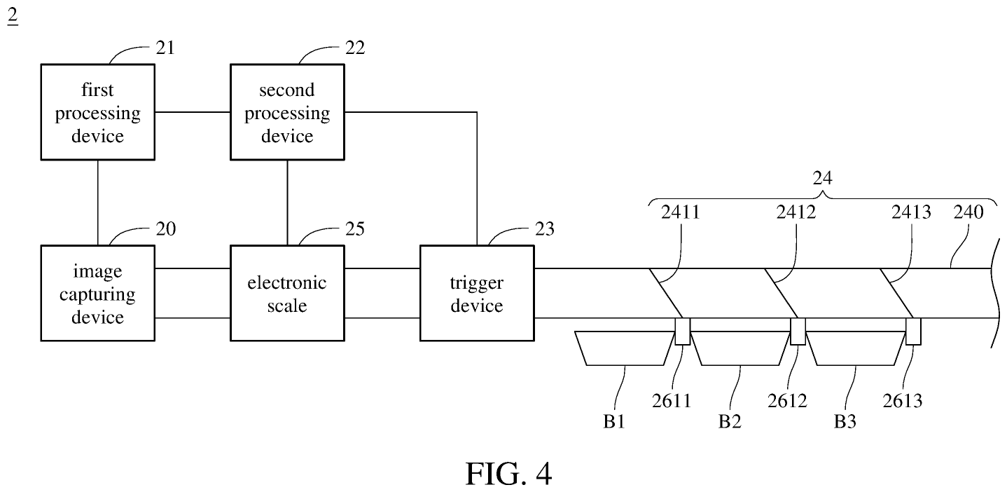

Please refer to FIG. 4, wherein FIG. 4 is a functional block diagram illustrating a one-way data processing system according to another embodiment of the present disclosure. As shown in FIG. 4, the one-way data processing system 2 includes an image capturing device 20, a first processing device 21, a second processing device 22, a trigger device 23, a conveyor device 24, an electronic scale 25 and a number of notification devices 2611, 2612 and 2613, wherein the conveyor device 24 includes a conveyor belt 240 and a number of swing arms 2411, 2412 and 2413. The image capturing device 20, the first processing device 21, the second processing device 22, the trigger device 23 and the conveyor device 24 of the one-way data processing system 2 are approximately the same as the image capturing device 10, the first processing device 11, the second processing device 12, the trigger device 13 and the conveyor device 14 of the one-way data processing system 1 shown in FIG. 1, their repeated descriptions are omitted herein. In addition, the second processing device 22 may also include the memory 120 and/or the circular queue 121 shown in FIG. 3. The notification devices 2611 to 2613 are selectively disposed. Specifically, the one-way data processing system 1 shown in FIG. 1 may also be selectively disposed with a number of notification devices corresponding to a number of candidate exit locations respectively.

The electronic scale 25 may be electrically connected to the second processing device 22 or in communication connection with the second processing device 22. The electronic scale 25 may be used to weigh the weight of the target object, and transmit the weight of the target object to the second processing device 22. As shown in FIG. 4, the electronic scale 25 is disposed on the conveyor belt 240, and configured to measure the weight of the target object, and transmit the weight of the target object to the second processing device 22.

In this embodiment, the first processing device 21 may transmit the type of the target object obtained by performing image recognition to the second processing device 22. Specifically, the first processing device 21 may write the type of the target object into the circular queue of the second processing device 22 for the second processing device 22 to use. Therefore, information of the type of the target object recognized by the first processing device 21 may be avoided from being overwritten by information of another type of another target object recognized by the first processing device 21 before read by the second processing device 22. Therefore, the second processing device 22 may obtain the correct exit information for the target object to be unloaded from the current exit location, thereby solving the problem of operation error caused by different processing speeds of two processing devices. In addition, the electronic scale 25 may also write the weight of the target object into the circular queue of the second processing device 22 to transmit the weight of the target object to the second processing device 22. In other words, the circular queue of the second processing device 22 may record the type and weight of the target object at the same time. Moreover, format of data written into the circular queue by the first processing device 21 may be different from format of data written into the circular queue by the electronic scale 25. When the second processing device 22 reads the circular queue, the second processing device 22 may determine whether the format of the data stored in the circular queue is the weight or type of the target object, and reads weight information and type information with the earliest writing time from the circular queue to determine the exit information. The second processing device 22 stores the level-exit correspondence table. Accordingly, the second processing device 22 may obtain the exit information according to the level-exit correspondence table, the type of the target object and the weight of the target object. The level-exit correspondence table stored by the second processing device 22 may be in the form of table 1 or table 2 shown above.

In yet another embodiment, the first processing device 21 stores a number of memory starting points corresponding to types of target object, and the second processing device 22 may further store classes of a number of weight ranges. The first processing device 21 may transmit the memory starting point (designated memory starting point) corresponding to the type of the target object to the second processing device 22, especially by writing the memory starting point into the circular queue. The second processing device 22 adds the memory starting point corresponding to the type of the target object and the class corresponding to the weight of the target object to obtain the target memory location, and look up the level-exit correspondence table to find the corresponding target exit location. In this embodiment, the level-exit correspondence table stored by the second processing device 22 may only include the candidate memory location column and the candidate exit location column.

For example, the first processing device 21 pre-stores the memory starting point D(m) corresponding to a first type and the memory starting point D(m+3) corresponding to a second type, the second processing device 22 pre-stores class 0 of a first weight range, class 1 of a second weight range and class 2 of a third weight range. Assuming that the type of the target object is the first type and the weight class is class 2, then the first processing device 21 transmits the memory starting point D(m) to the second processing device 22, and the second processing device 22 adds the memory starting point D(m) with the weight class 2 to obtain the target memory location D(m+2).

In the one-way data processing system 2 of FIG. 4, the notification devices 2611 to 2613 may be electrically connected to the second processing device 22 or in communication connection with the second processing device 22. The notification devices 2611 to 2613 may be lights, speakers, etc. the notification devices 2611 to 2613 are controlled by the second processing device 22 to output notification. Specifically, the notification devices 2611 to 2613 are disposed at the candidate exit locations respectively. The second processing device 22 controls one of the notification devices 2611 to 2613 corresponding to the target exit location to output a notification when determining the accumulated weight corresponding to the target exit location among the candidate exit locations is greater than a default weight. The notification may be implemented in the form of lighting, speaker outputting audio, etc., for indicating the corresponding basket is full. In the example of fishery, the default weight may be 20 kg, but the present disclosure is not limited thereto.

For example, assuming that the target exit location is the candidate exit location corresponding to the first swing arm 2411, and after the target object is unloaded into the basket B1, the second processing device 22 determines that the accumulated weight (the accumulated weight of the basket B1) corresponding to the target exit location equals to or is greater than the default weight, then the second processing device 22 may control the notification device 2611 to output notification. Accordingly, the system may automatically determine whether the basket needs to be replaced (with an empty basket), thereby reducing the required manpower.

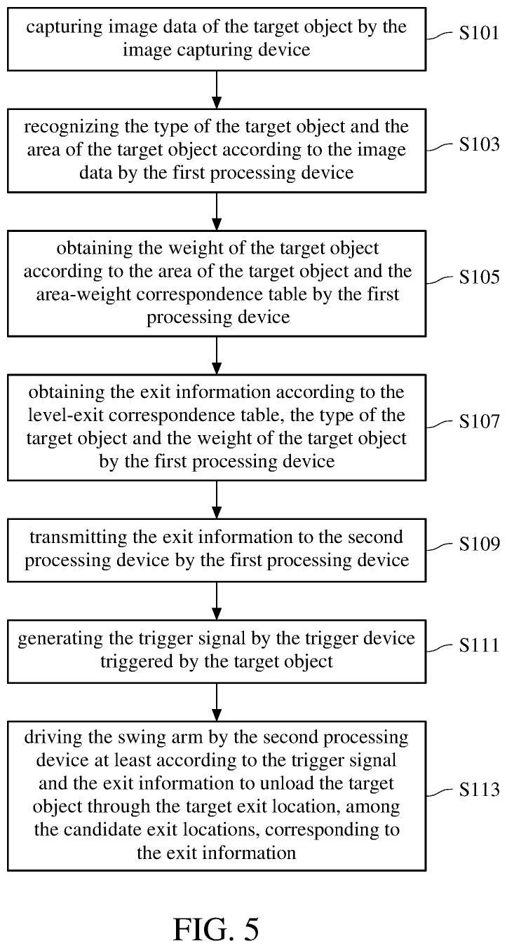

Please refer to FIG. 1 and FIG. 5, wherein FIG. 5 is a flowchart illustrating an operation of the one-way data processing system according to an embodiment of the present disclosure. The flowchart shown in FIG. 5 may be adapted to the one-way data processing system 1 shown in FIG. 1. As shown in FIG. 5, the operation of the one-way data processing system 1 includes: step S101: capturing image data of the target object by the image capturing device; step S103: recognizing the type of the target object and the area of the target object according to the image data by the first processing device; step S105: obtaining the weight of the target object according to the area of the target object and the area-weight correspondence table by the first processing device; step S107: obtaining the exit information according to the level-exit correspondence table, the type of the target object and the weight of the target object by the first processing device; step S109: transmitting the exit information to the second processing device by the first processing device; step S111: generating the trigger signal by the trigger device triggered by the target object; and step S113: driving the swing arm by the second processing device at least according to the trigger signal and the exit information to unload the target object through the target exit location, among the candidate exit locations, corresponding to the exit information.

In step S101, the image capturing device 10 takes image(s) of the target object to obtain the image data, wherein the image data may include one frame or consecutive frames of images.

In step S103 and step S105, the first processing device 11 recognizes the type of the target object and the area of the target object according to the image data, and obtains the weight of the target object according to the area of the target object and the area-weight correspondence table.

In step S107, the first processing device 11 obtains the exit information according to the level-exit correspondence table, the type of the target object and the weight of the target object, wherein the exit information includes the target exit location corresponding to the target object.

In step S109, the first processing device 11 transmits the exit information to the second processing device 12, for the second processing device 12 to determine the timing of driving the swing arm to unload the target object based on the exit information.

In step S111, the trigger device 13 is triggered by the target object to generate the trigger signal, and outputs the trigger signal to the second processing device 12. In step S113, the second processing device 12 drives one of the swing arms 1411 to 1413 corresponding to the target exit location at least according to the trigger signal and the exit information, for the target object to be unloaded into a corresponding one of the baskets B1 to B3.

In another embodiment, the operation shown in FIG. 5 further includes transmitting the weight of the target object, the type of the target object and the exit information etc. to the second processing device (may be performed by step S109) and step of accumulating the accumulated weight (may be performed after step S113). In yet another embodiment, in addition to the above steps, the operation further includes determining whether the accumulated weight is greater than the default weight after accumulating the accumulated weight, and controlling the notification device corresponding to the target exit location to output a notification when determining that the accumulated weight of the target exit location is greater than the default weight.

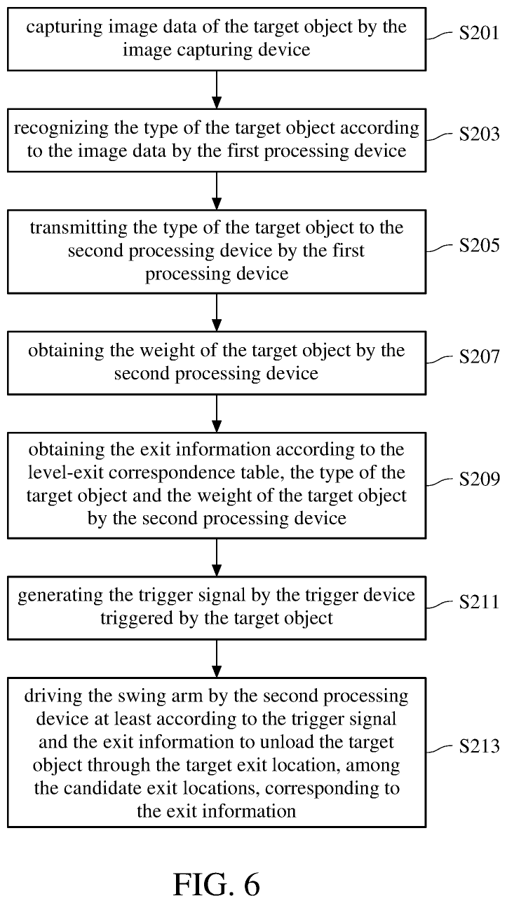

Please refer to FIG. 1 and FIG. 6, wherein FIG. 6 is a flowchart illustrating an operation of the one-way data processing system according to another embodiment of the present disclosure. The flowchart shown in FIG. 6 may be adapted to the one-way data processing system 2 shown in FIG. 4. As shown in FIG. 6, the operation of the one-way data processing system 2 includes: step S201: capturing image data of the target object by the image capturing device; step S203: recognizing the type of the target object according to the image data by the first processing device; step S205: transmitting the type of the target object to the second processing device by the first processing device; step S207: obtaining the weight of the target object by the second processing device; step S209: obtaining the exit information according to the level-exit correspondence table, the type of the target object and the weight of the target object by the second processing device; step S211: generating the trigger signal by the trigger device triggered by the target object; and step S213: driving the swing arm by the second processing device at least according to the trigger signal and the exit information to unload the target object through the target exit location, among the candidate exit locations, corresponding to the exit information.

Step S201, step S203, step S211 and step S213 shown in FIG. 6 are the same as step S101, step S103, step S111 and step S113 shown in FIG. 5, their repeated descriptions are omitted herein.

After identifying the type of the target object, in step S205, the first processing device 22 transmits the type of the target object to the second processing device 22. In step S207, the second processing device 22 obtains the weight of the target object through, for example, the electronic scale 25. In step S209, the second processing device 22 obtains the exit information according to the level-exit correspondence table, the type and weight of the target object, wherein the exit information includes the target exit location corresponding to the target object.

In still another embodiment, the operation in FIG. 6 further includes step of accumulating the accumulated weight (may be performed after step S213). In still yet another embodiment, in addition to the above steps, the operation further includes determining whether the accumulated weight is greater than the default weight after accumulating the accumulated weight, and controlling the notification device corresponding to the target exit location to output notification when determining that the accumulated weight of the target exit location is greater than the default weight.

The difference between embodiment of FIG. 5 and embodiment of FIG. 6 is that, in the embodiment of FIG. 5, the level-exit correspondence table is stored in the first processing device 11; and in the embodiment of FIG. 6, the level-exit correspondence table is stored in the second processing device 22. In addition, in the embodiment of FIG. 5, the weight of the target object is obtained by the first processing device 11 according to the area-weight correspondence table; and in the embodiment of FIG. 6, the weight of the target object is obtained by the second processing device 22 from the electronic scale 25.

Through the above structure, the one-way data processing system of the present disclosure may allow signal transmission from the first processing device to the second processing device to be more stable, without delay and error caused by back-and-forth communication. The one-way data processing system of the present disclosure may further automatically select target object, replacing the traditional way of relying on human eyes and worker's experience to perform recognition, thereby improving the accuracy of production line operations and reduce labor costs. In addition, through the structure of the circular queue, the target exit location of the target object may be avoided from being overwritten by new information before being read, thereby unloading the target object through the correct exit location.

What is claimed is:

1. A one-way data processing system, comprising:
a conveyor device comprising a conveyor belt and a plurality of swing arms, with the swing arms configured to unload a target object at one of a plurality of candidate exit locations;
an image capturing device disposed at the conveyor belt, and configured to capture image data of the target object;
a trigger device disposed at the conveyor belt, and configured to be triggered by the target object to generate a trigger signal;
a first processing device connected to the image capturing device, and configured to identify a type of the target object according to the image data; and
a second processing device connected to the trigger device and the first processing device, and configured to drive the swing arms to unload the target object at a target exit location corresponding to the exit information among the candidate exit locations at least according to the trigger signal and exit information;
wherein the first processing device or the second processing device is further configured to obtain a weight of the target object and obtain the exit information according to a level-exit correspondence table, the type of the target object and the weight of the target object, wherein the level-exit correspondence table comprises a plurality of type-weight levels corresponding to the candidate exit locations respectively, and a data transmission direction between the first processing device and the second processing device only comprises a direction from the first processing device to the second processing device.

2. The one-way data processing system according to claim 1, wherein the first processing device stores the level-exit correspondence table and an area-weight correspondence table associated with the target object, and the first processing device is further configured to calculate an area of the target object according to the image data, obtain the weight of the target object according to the area of the target object and the area-weight correspondence table, obtain the exit information according to the level-exit correspondence table, the type of the target object and the weight of the target object, and transmits the exit information to the second processing device.

3. The one-way data processing system according to claim 2, wherein the second processing device comprises:
a memory comprising a plurality of memory blocks, with each of the memory blocks recording an accumulated weight of a respective one of the candidate exit locations;
wherein the level-exit correspondence table further comprises a plurality of candidate memory locations corresponding to the candidate exit locations respectively, the first processing device further transmits the weight of the target object and a target memory location corresponding to the target exit location among the candidate memory locations to the second processing device when obtaining the exit information, for the second processing device to add the weight of the target object to the accumulated weight of the target exit location.

4. The one-way data processing system according to claim 3, further comprising:
a plurality of notification devices disposed at the candidate exit locations respectively and connected to the second processing device,
wherein the second processing device further controls a notification device corresponding to the target exit location among the notification devices to output a notification when determining the accumulated weight is greater than a default weight.

5. The one-way data processing system according to claim 2, wherein the second processing device comprises a circular queue, and the first processing device transmits the exit information to the second processing device by writing the exit information into the circular queue.

6. The one-way data processing system according to claim 1, further comprising:
an electronic scale disposed at the conveyor belt, connected to the second processing device, and configured to measure the weight of the target object and transmit the weight of the target object to the second processing device;
wherein the first processing device transmits the type of the target object to the second processing device, and the second processing device stores the level-exit correspondence table and obtains the exit information according to the level-exit correspondence table, the type of the target object and the weight of the target object.

7. The one-way data processing system according to claim 6, wherein the level-exit correspondence table further comprises a plurality of candidate memory locations corresponding to the candidate exit locations respectively, and the second processing device comprises:
a memory comprising a plurality of memory blocks corresponding to the candidate memory locations respectively, with each of the memory blocks recording an accumulated weight of a respective one of the candidate exit locations;
wherein the second processing device further adds the weight of the target object to the accumulated weight of the target exit location when obtaining the exit information.

8. The one-way data processing system according to claim 7, further comprising:
a plurality of notification devices disposed at the candidate exit locations respectively and are connected to the second processing device,
wherein the second processing device further controls a notification device corresponding to the target exit location among the notification devices to output a notification when determining the accumulated weight is greater than a default weight.

9. The one-way data processing system according to claim 6, wherein the level-exit correspondence table further comprises a plurality of candidate memory locations corresponding to the candidate exit locations respectively, the first processing device stores a plurality of memory starting points corresponding to a plurality of target object types, and transmits the type of the target object to the second processing device by transmitting a designated memory starting point corresponding to the type of the target object from the memory starting points to the second processing device, wherein the second processing device comprises:
a memory comprising a plurality of memory blocks corresponding to the candidate memory locations respectively, with each of the memory blocks recording an accumulated weight of a respective one of the candidate exit locations;
wherein the second processing device further stores a plurality of weight classes, obtains a target memory location from the candidate memory locations according to the designated memory starting point and one of the weight classes corresponding to the weight of the target object, and obtains the exit information according to the target memory location and the level-exit correspondence table, and the second processing device further adds the weight of the target object to the accumulated weight of the target exit location according to the level-exit correspondence table when obtaining the exit information.

10. The one-way data processing system according to claim 6, wherein the second processing device comprises a circular queue, and the first processing device transmits the type of the target object to the second processing device by writing the type of the target object into the circular queue, and the electronic scale transmits the weight of the target object to the second processing device by writing the weight of the target object into the circular queue.
